(19) United States
(12) Patent Application Publication
(10) Pub. No.: US 2010/0146111 A1
(43) Pub. Date: Jun. 10, 2010

(54) EFFICIENT COMMUNICATION IN A NETWORK

(75) Inventors: Yotam Shacham, Palo Alto, CA (US); Guy Ben-Artzi, Palo Alto, CA (US); Alexei Alexevitch, Hertzlia (IL); Amatzia Ben-Artzi, Palo Alto, CA (US); Tal Lavian, Sunnyvale, CA (US); Alexander Glyakov, Petach Tikva (IL); Russell W. McMahon, Woodside, CA (US); Yehuda Levi, Rishon Lezion (IL)

Correspondence Address: CONNOLLY BOVE LODGE & HUTZ LLP, 1875 EYE STREET, N.W., SUITE 1100, WASHINGTON, DC, 20006, US

(73) Assignee: Real Dice Inc., Carson City, NV (US)

(21) Appl. No.: 12/630,186

(22) Filed: Dec. 3, 2009

Related U.S. Application Data
(60) Provisional application No. 61/200,932, filed on Dec. 4, 2008.

(51) Int. Cl. G06F 15/173; G06F 15/16

(52) U.S. Cl. 709/224; 709/247

(57) ABSTRACT

A connection may be established between a first device and a second device in a network. Thereafter, the first device may be monitored for one or more performance parameters. Subsequently, full state information of an application may be processed at the first device based on the performance parameters, and the processed full state information may be transmitted by the first device to the second device. Thereafter, one or more state changes of the application may be processed at the first device based on the one or more performance parameters while the connection is active. Subsequently, one or more processed state changes of the application may be transmitted sequentially by the first device to the second device.

### CROSS-REFERENCE TO RELATED APPLICATION

This application draws priority from U.S. Provisional Patent Application No. 61/200,932, filed on Dec. 4, 2008, and hereby incorporated by reference herein in its entirety.

### FIELD OF THE INVENTION

Various embodiments of the invention may relate to communication in a network and more specifically to improving the efficiency of communication in a network.

### BACKGROUND OF THE INVENTION

Various users across the globe communicate or perform various activities on computer and device networks. Moreover, the users interact with each other through the networks, such as the Internet. Typically, the users use devices like personal computers to interact over the Internet. The users can interact from various Internet websites or social networking sites, for example, Facebook, Myspace, Hi5, and Orkut etc. Recently, the development in mobile devices such as cell phones, smartphones and PDAs, computers, laptops and the like has enabled them to be used for performing various activities on networks such as the Internet. Moreover, the mobile devices can be used for real-time interaction with other users on the network. The interaction or communication can be in the form of chatting, playing interactive online games, browsing, shopping, music, video, banking, business and the like.

The rapid pace of innovation in technology has generated various types of devices and platforms. Moreover, the number of devices is increasing rapidly. For example, there are various operating systems available for the devices such as Windows, Linux, Macintosh, and Symbian, etc. Moreover, a large number of J2ME platforms are available for the mobile devices such as cell phones. Furthermore, the mobile devices have a wide range of capabilities in terms of screen size, screen type, screen resolution, processor, and memory etc. The advancement in technology has enabled multi-user interaction on the network, for example multi-player games on mobile devices. Moreover, with rapid decline in prices of hardware, advanced and inexpensive devices are readily available. Furthermore, advancements in software, operating systems, and input/output interfaces have enabled the development of high performance media capabilities on devices. Interactive applications such as media games are now being developed which allow multi-user interactions on networks. As a result, the number of users and the requirement for the quality of service in the network is increasing rapidly.

Typically, interactive applications require constant communication between the users. Therefore, a large amount of bandwidth may be required to maintain the communication. The bandwidth available on a device depends on the type of network and the hardware or software of a device. For example, mobile network infrastructures such as in rural areas or otherwise underdeveloped areas may have less bandwidth as compared to infrastructures in developed cities or areas. As a result, the user with slow network connection may experience latency in communication. Moreover, the information to be transmitted can be limited due to a low bandwidth network. Therefore, in case of some applications, for example, competitive online games, this may result in fairness issues. Interactive applications such as chatting or mobile games may require real time updating of information, which induces latency in communication. Furthermore, the scalability of these multi-user applications may depend on the efficiency and quality of service of network communications.

A mechanism may, therefore, desirable for efficient communication in the network. Moreover, it may be desirable for the mechanism to be scalable.

### SUMMARY

Various embodiments of the invention may provide a method for efficient communication in a network. The method may comprise establishing a connection between a first device and a second device in the network; monitoring the first device for one or more performance parameters; processing full state information of an application at the first device, wherein the full state information is processed based on the performance parameters; transmitting the processed full state information of the application by the first device to the second device; processing one or more state changes of the application at the first device, wherein the state changes are processed based on the one or more performance parameters, and wherein the state changes are processed while the connection is active; and transmitting sequentially one or more processed state changes of the application by the first device to the second device.

Embodiments of the invention may further provide an apparatus for efficient communication in a network. The apparatus may comprise a memory configured to store full state information of an application and one or more state changes of the application; a monitoring module configured to monitor one or more performance parameters; an analyzer module configured to process the full state information and the state changes of the application based on the one or more performance parameters, and wherein the state changes are processed while a network connection is active; and a transmission module configured to: establish the connection in the network; transmit the processed full state information; and transmit sequentially the processed state changes

Embodiments of the invention may further provide a system for efficient communication in a network. The system may comprise means for establishing a connection between a first device and a second device in the network; means for monitoring the first device for one or more performance parameters; means for processing full state information of an application at the first device, wherein the full state information is processed based on the performance parameters; means for transmitting the processed full state information of the application by the first device to the second device; means for processing one or more state changes of the application at the first device, wherein the state changes are processed based on the one or more performance parameters, and wherein the state changes are processed while the connection is active; and means for transmitting sequentially one or more processed state changes of the application by the first device to the second device.

Embodiments of the invention may further provide a computer-readable medium containing instructions for performing a method for efficient communication in a network. The method may comprise establishing a connection between a first device and a second device in the network; monitoring the first device for one or more performance parameters; processing full state information of the application at the first device, wherein the full state information is processed based on the performance parameters; transmitting the processed full state information of the application by the first device to the second device; processing one or more state changes of the application at the first device, wherein the state changes are processed based on the one or more performance parameters, and wherein the state changes are processed while the connection is active; and transmitting sequentially one or more processed state changes of the application by the first device to the second device.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is an environment where various embodiments of the invention may function;

FIG. 2 is a block diagram of an apparatus for efficient communication in a network, according to an embodiment of the invention;

FIG. 3A is a block diagram illustrating efficient communication between a client and a server in the network, in accordance with an embodiment of the invention;

FIG. 3B is a block diagram illustrating efficient communication between a client and a server in a network, in accordance with another embodiment of the invention;

FIG. 4 illustrates a flowchart diagram for efficient communication in the network, in accordance with an embodiment of the invention;

FIG. 5 illustrates a flowchart diagram for efficient communication in the network, in accordance with an embodiment of the invention; and

FIG. 6 illustrates a flowchart diagram for deciding a compression ratio for information, in accordance with an embodiment of the invention.

### DETAILED DESCRIPTION OF EMBODIMENTS OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

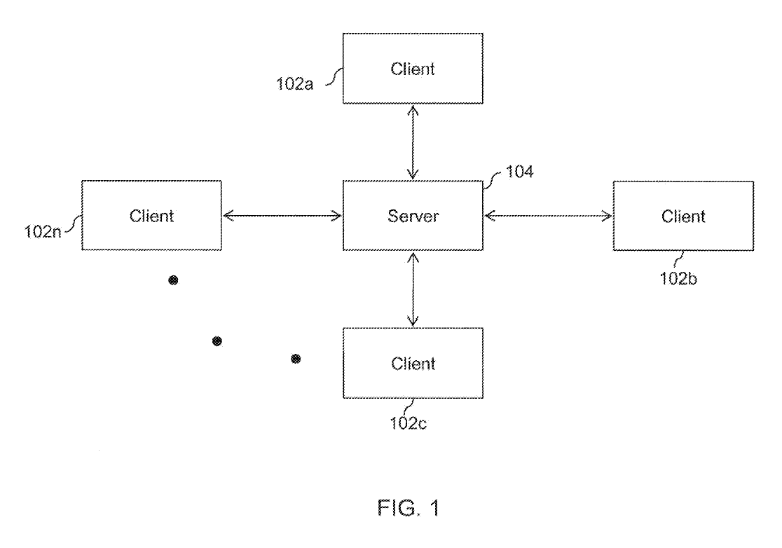

FIG. 1 is an environment where various embodiments of the invention may function. As shown, devices such as clients 102a-n may communicate to interact and share information in a network with devices such as a server 104. Clients 102a-n can be, but are not limited to a mobile phone, a laptop, a personal computer, a smartphone and the like. Similarly, various other devices can be connected in the network through server 104. Clients 102a-n can have different hardware and software platforms. Examples of software platforms include operating systems such as Windows, Linux, Macintosh, Symbian, and so forth. Moreover, clients 102a-n may have different hardware, such as the screen size, screen resolution, audio and video functionality, processors and so forth. Therefore, the applications executing on the clients 102a-n and server 104 will generally be compatible with the operating systems and hardware platform of these devices.

Clients 102a-n may interact with each other through server 104 in real-time for activities such as chatting, playing games, banking and so forth. Clients 102a-n may interact from different types of networks. For example, client 102a may communicate with server 104 through a mobile network with a maximum bandwidth of 14.4 kbps, and client 102b may communicate through an Ethernet network with a maximum bandwidth of 2 Mbps. Moreover, clients 102a-n can have different hardware and software capabilities. For example, client 102a may be a device such as a mobile phone and client 102b may be device such as a personal computer. Therefore, the communication between clients 102a-n may generally be based on various network and device performance parameters. Examples of the performance parameters may include, but are not limited to, the bandwidth of the network, the type of network, communication protocols used, latency in communication, a user's online time, processing power of clients 102, processor usage of clients 102, memory of clients 102, and other parameters such as electronics, batteries, screen, radio, communications of clients 102 and so forth.

Interactive applications may often require a large amount of real-time information transfer between clients 102 and server 104. In such cases, a lot of network bandwidth may be required to avoid latency in the network. For example, in case of interactive multi-player games, real-time information may be transferred regarding the status of the player, statistics of the game, state of the game, game data and so forth. Typically, in network communication, clients 102 connect to server 104, and thereafter the clients 102 and server 104 pass the data to one another, until the connection is closed. For example, in case of an online game, client 102 and server 104 can regularly exchange the complete information state of the game or the user. The network traffic in this case can be defined as: N×STATE, where N is number of operations and STATE is information that is large enough to describe an information state of a user. The user information state can be for example, but not limited to, joined the game room, left the game room, changed a position in the game and many other states possible in case of a game. However, a lot of bandwidth may be required to transfer this information regularly, which may lead to inefficiency of the network bandwidth.

Therefore, mechanisms may be used to improve the efficiency by providing more information on the same bandwidth of the network. However, a large Central Processing Unit (CPU) or processor, memory and more complex logic may be required to enable efficient communication in the network. The processor usage of a device can be offset by the use of additional memory in case of real-time applications. For example, the information that is to be processed can be cached before being processed. As a result, more information can be processed; however, more processing usage may be required to process the cached data. Similarly, in case the processing usage of the device is high, then less data can be used for processing. Therefore, various performance parameters of clients 102 or server 104 may be analyzed and an optimum value selected to make efficient use of the network bandwidth.

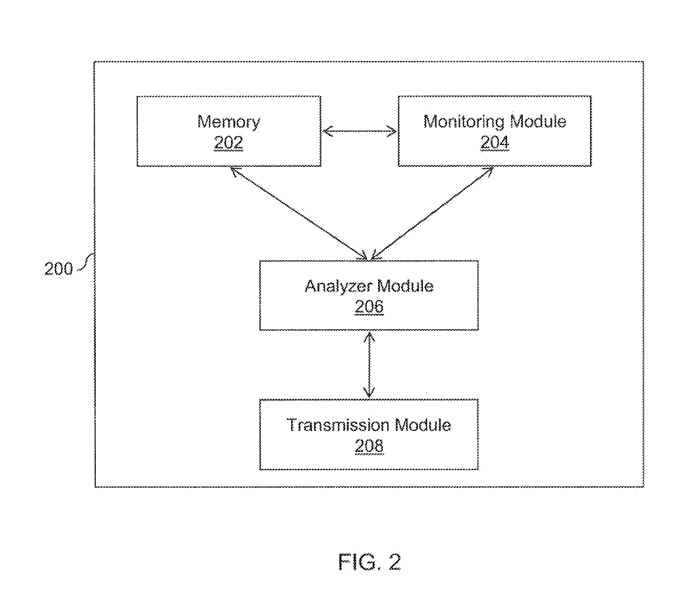

FIG. 2 is a block diagram of a system 200 for efficient communication in the network. System 200 may function to manage the bandwidth for communication in the network. In an embodiment of the invention, system 200 can be implemented as hardware, software or firmware on devices such as clients 102a-n and server 104. In an embodiment of the invention, system 200 is an application executing on clients 102a-n and server 104.

A real-time application can be executed on client 102a. For example, the real-time application can be an online computer game. In this case, client 102a may communicate regularly with server 104 for game information and other services. In an embodiment of the invention, server 104 is a game server. Client 102a can have other applications executing along with the online computer game. The execution of the application may require usage of network bandwidth for transmission of game information. Further, the application may require usage of a processor of client 102a for processing the application information. Therefore, the performance of client 102a may need to be monitored to enable efficient communication on the network. The application executing on client 102a can include various information states. For example, in case of an online multi-user game or a chat application, full state information of the application may include, but is not limited to, the details regarding the Internet Protocol (IP) addresses of all the users connected, server address, Graphical User Interface (GUI) data of the application, number of users connected, a stage of user, user messages, the state change of the user and so forth. The state change can be, for example, a move taken by the user in an online game, a new message sent by the user, a presence message change of the user, or any other change based on the type of application. For example, the state change in case of an online computer game can be: a user joined the game room, left the game room, changed a position in the game and many other states possible in case of a game. The full state information of the application can include a large amount of data and may require substantial network bandwidth. However, the state change information may require much lower network bandwidth than the full state information.

System 200 may include a memory 202 to store the performance parameters of a client 102a and application information. Examples of memory 202 include, but are not limited to, a Random Access Memory (RAM), a Read Only Memory (ROM) and so forth. System 200 may include a monitoring module 204 for monitoring the performance parameters of a client 102a and application information. Monitoring module 202 may monitor the network and client 102a to gather data that may include, but which is not limited to, the type of network, amount of information to be transmitted, type of information to be transmitted, total and available bandwidth of the network, network capacity ratio, capacity of processor and/or processor usage. The network capacity ratio can be defined as a ratio of size of the information to be transmitted to an available bandwidth of the network. Further, monitoring module 204 may monitor the application to gather the application information such as full state information and/or state changes. Monitoring module 204 sends the monitored information to memory 202 for storage. In an embodiment of the invention, monitoring module 204 monitors client 102a regularly after a predetermined time period. In another embodiment of the invention, monitoring module 204 monitors client 102a in real-time. Monitoring module 204 can be implemented as a processor, software, firmware or a combination thereof.

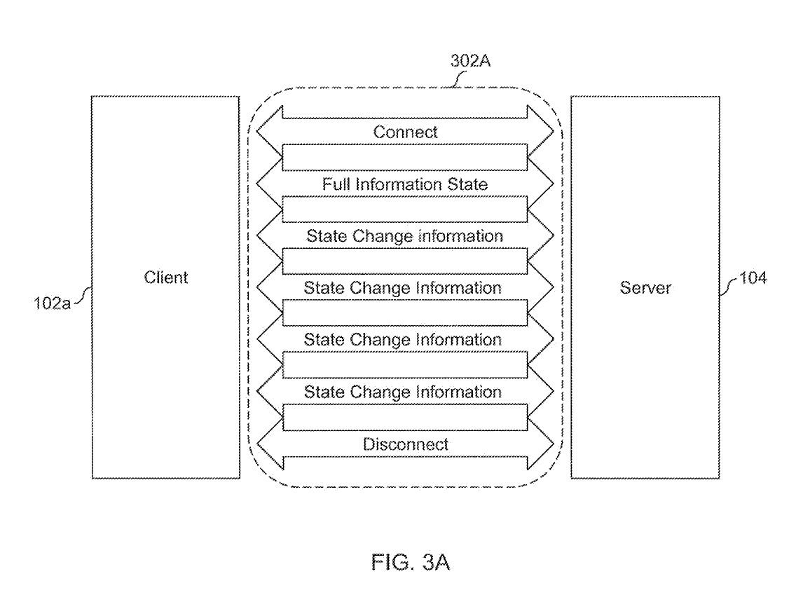

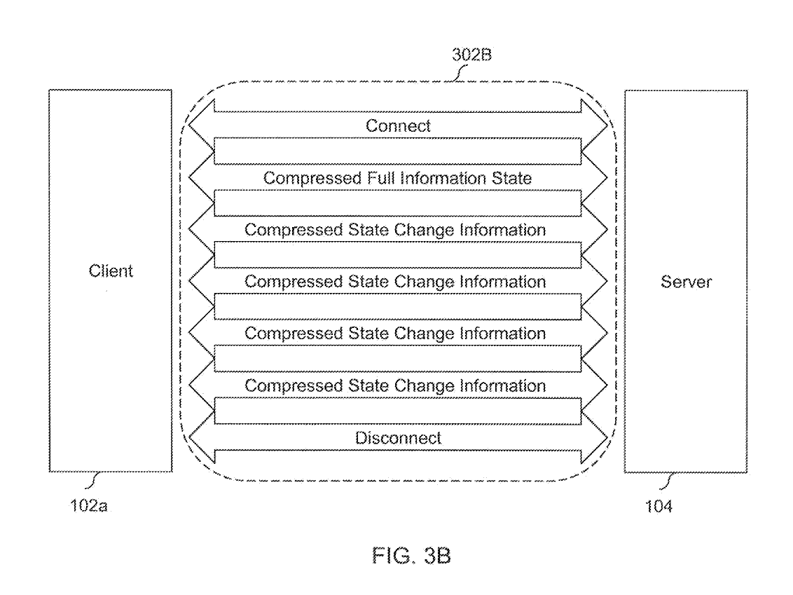

An analyzer module 206 may process the application information stored in memory 202. Analyzer module 206 may process the full information state and/or state changes of the application based on the performance parameters monitored by monitoring module 204. In an embodiment of the invention, analyzer module 206 compresses the application information. In another embodiment of the invention, analyzer module 206 decompresses the application information. For example, analyzer module 206 may use compression algorithms such as ZIP to compress or decompress the information. In an embodiment of the invention, analyzer module 206 processes the full information state once on establishing the connection, and thereafter only the state changes are processed. The state changes may be processed sequentially as they are monitored by monitoring module 204. Analyzer module 206 may select the information to be transmitted by the client 102a based on the state of network connection and state of the application. For example, processed full state information of the application may be transmitted once after the connection between client 102a and server 104 is established. Similarly, only the processed state changes may be transmitted after the transmission of the full state information. Moreover, the analyzer module 206 may decide when to stop the transmission of the application information. Various embodiments of processes relating to transmitting the information are explained in detail in conjunction with FIGS. 3A, 3B, 4 and 5.

The application information processed by the analyzer module 206 may be forwarded to a transmission module 208 for transmitting to server 104. In an embodiment of the invention, analyzer module 206 may signal transmission module 208 to receive or transmit the information. Further, transmission module 208 may establish a connection between client 102a and server 104. In an embodiment of the invention, transmission module 208 may use transmission protocols such as HTTP, TCP, UDP, HTTPS, SIP, or other protocols for transmitting the data. In an embodiment of the invention, transmission module 208 selects the protocol based on the type of network. In another embodiment of the invention, transmission module 208 selects the protocol based on the network parameters and device resources. For example, transmission module 208 may use tunneling to send data in case the network does not support a particular protocol. For example, HTTP, FTP, SSH protocols can be encapsulated with a protocol supported by mobile phone network such as TCP.

FIG. 3A is a block diagram illustrating efficient communication between client 102a and server 104 in the network, in accordance with an embodiment of the invention. As discussed above, typically, in network communication, a client connects to a server and thereafter the client and the server pass the data to one another, until one of the two closes the connection or the application is closed. For example, in case of an online game, the client and the server may exchange the complete state of the game or the user to the server. Therefore, the network traffic in this case can be defined as: N×STATE, where N is number of operations and STATE is information that is large enough to describe the user state.

In the embodiment shown in FIG. 3A, client 102a connects to server 104 and subsequently transfers the full state information of the application. Block 302A depicts the communication between client 102a and server 104, in an embodiment of the invention. Thereafter, client 102a and server 104 communicate sequentially only the changes or differences in the states, and not the full state information of the application. For example, in case of an online game, client 102a may transmit only the change in the user position, and not the complete game state, to server 104. In this case, the network traffic can be defined as:

STATE+(N−1)×DIFFERENCE

where N is number of operations, STATE is information that is large enough to describe the application state, and DIFFERENCE is information that is large enough to describe a change in application state. In an embodiment of the invention, the size of DIFFERENCE is less than the size of STATE. As a result, much less information may need to be transmitted on the network as compared to the typical network communication.

FIG. 3B is a block diagram illustrating communication between client 102a and server 104 in the network, in accordance with another embodiment of the invention. As shown in FIG. 3B, the information to be transmitted in the network is processed. Block 302B depicts the communication between client 102a and server 104, in an embodiment of the invention. Client 102a connects to server 104 and transmits the processed full state of the application in a compressed format. Thereafter, the processed changes or differences in the states are shown being passed sequentially in a compressed format. In this case, the total network traffic can be defined as:

K×(STATE+(N−1)×DIFFERENCE)

where N is number of operations, STATE is information that is large enough to describe the application state, and DIFFERENCE is information that is large enough to describe a change in application state, and K is a compression ratio, where K is a real number less than 1. The compression ratio can be defined as the ratio of the size of compressed information to the size of uncompressed information. As a result, further reduction in network traffic may be achieved, as compared to the network communication discussed in conjunction with FIG. 3A.

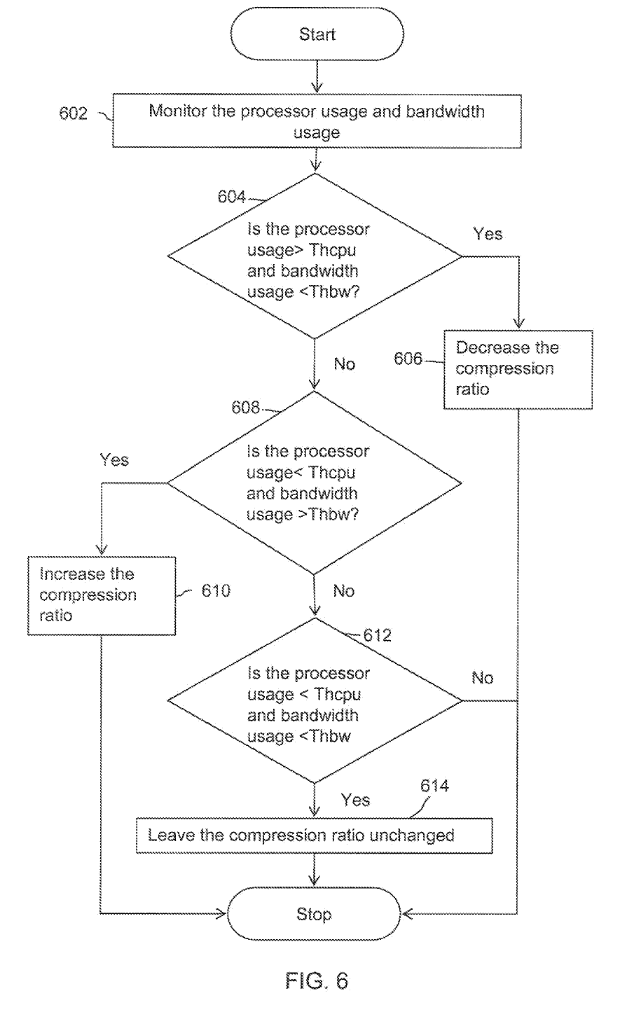

Various algorithms and available compression standards can be used to compress and transmit the information. In an embodiment of the invention, client 102a and server 104 can agree to use meta protocols to optimize the size of transferred information. Therefore, efficiency of the existing bandwidth availability can be increased. In another embodiment of the invention, a compression protocol such as ZIP is used to compress the data. The amount of compression of the data can be decided based on various parameters such as processor usage, latency, total network bandwidth, total used bandwidth, user statistics such as time spent online, use of communication functionalities, etc. In an embodiment of the invention, a threshold value may be decided for each of the maximum processor usage and maximum allowed bandwidth usage. The threshold values are generally less than 100% for processor usage and bandwidth usage, in an embodiment of the invention. The algorithm that may be used by analyzer module 206 for deciding compression ratio is explained in detail in conjunction with FIG. 6.

In an embodiment of the invention, clients 102a-n interact through server 104, therefore, the application state is transmitted only once to server 104 and subsequently transferred to each of clients 102a-n. As a result, client 102a transmitting the update is not required to transmit the information to all the other clients in the network, and bandwidth can be saved. For example, in case of an online card game, when a user on client 102a changes the position of his card, the information is transmitted to server 104. Subsequently, server 104 transmits the position to other clients 102b-n on the network. Therefore, client 102a is not required to connect to each of the other clients 102b-n directly to transmit the information. As a result, the network bandwidth may be conserved.

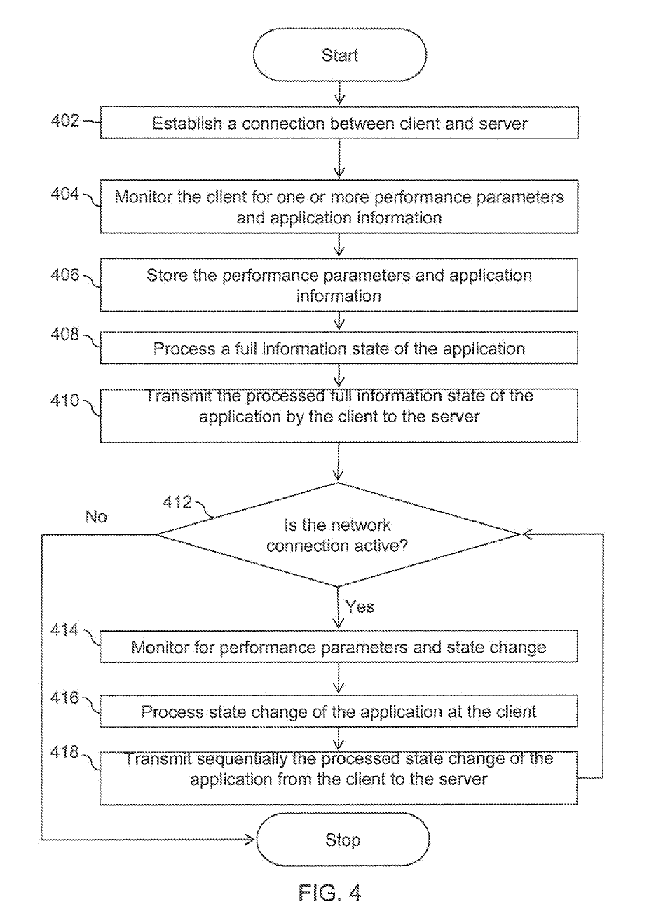

FIG. 4 illustrates a flowchart diagram for efficient communication in the network, in accordance with an embodiment of the invention. A connection is established 402 between client 102a server 104 for communication over the network. In an embodiment of the invention, client 102a communicates with server 104 to transfer information regarding the application. At 404, client 102a and/or the network may be monitored to gather information related to performance parameters, and the application information may be obtained by monitoring module 204. Thereafter, the performance parameters and the application information may be stored 406, e.g., in memory 202. In an embodiment of the invention, the application information can be full state information or information regarding the state changes.

At 408, the full state information may be processed based on the parameters by processor 206. Analyzer module 206 may compress the information. The compression ratio of the information may be based on parameters such as processor usage and/or bandwidth available on the network. An exemplary process of deciding the compression ratio is explained in detail in conjunction with FIG. 6. In an embodiment of the invention, the compression ratio of the information can be updated in real-time based on information gathered by monitoring module 204.

In an embodiment of the invention, analyzer module 206 may also be used to decompress information (e.g., information received in compressed form). For example, the information received from server 104 at client 102a may be decompressed.

Returning to FIG. 4, subsequent to 408, the processed information may be transmitted by transmission module 208, at 410. In an embodiment of the invention, the processed full state information may be transmitted based on the type of the network and the protocols supported by the network.

At 412, it is determined whether the connection between client 102a and server 104 is active. In case the connection is active, then the state change of the application is monitored 414. In an embodiment of the invention, the state change may be stored in memory 202. Subsequently, at 416, the state change may be processed by analyzer module 206. The state change may be compressed by analyzer module 206 based on the performance parameters. Thereafter, the processed state change information may be transmitted 418, e.g., by transmission module 208 to server 104. The state changes may be monitored, processed and transmitted until the connection is closed.

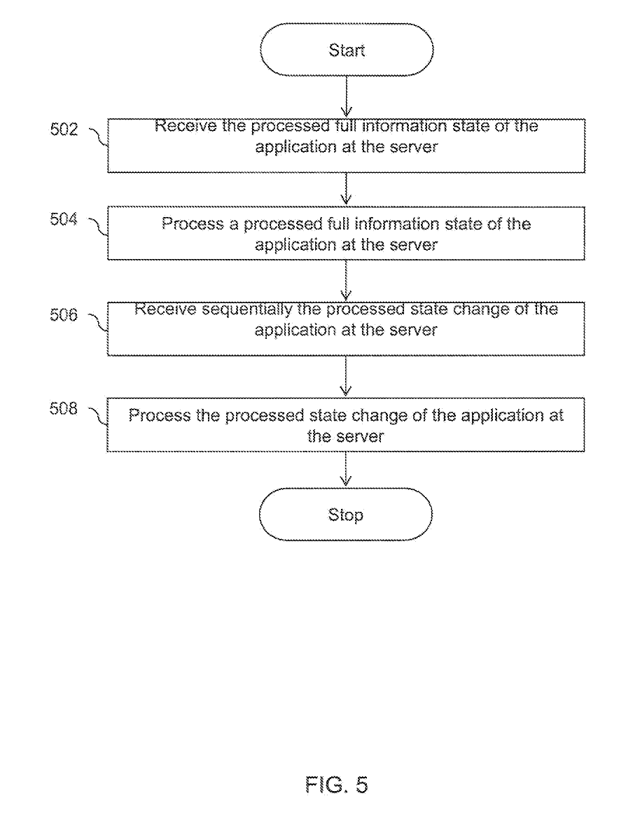

FIG. 5 illustrates a flowchart diagram for efficient communication in the network, in accordance with another embodiment of the invention. At 502, processed full information state of the application may be received at server 104 from client 102a. The processed full information state may be received by a transmission module 208. In an embodiment of the invention, processed full state information may be received at client 102a from server 104. Thereafter, at 504 the processed full information state of the application may be processed at server 104. In an embodiment of the invention, the processed full information state is decompressed at server 104. The processed full information state may be, processed by analyzer module 206. In an embodiment of the invention, the processed full state information may be processed at client 102a. At 506, processed state changes may be received sequentially at server 104. The processed state changes may be received by transmission module 208. Subsequently, the processed state changes may be processed at server 104, e.g., by analyzer module 206. In an embodiment of the invention, the processed state changes are decompressed at server 104. In an embodiment of the invention, the processed state changes are processed at client 102a.

The process is explained above to be executing at server 104 for the purpose of clarity, and it should be apparent to a person skilled in the art that the processes can be performed at client 102a-n and are not limited to server 104. That is, processes similar to those shown in and described with respect to FIGS. 4 and 5 may be used for communications in either or both directions between clients 102a-n and server 104.

FIG. 6 illustrates a flowchart diagram for deciding the compression ratio for information, in accordance with an embodiment of the invention. The communication in the network can be made efficient by managing the bandwidth and processor usage. Analyzer module 206 may compress information to be transmitted on the network to improve the efficiency of communication. The compression ratio of the information may be decided based on the parameters such as processor usage and/or bandwidth usage.

In an embodiment of the invention, a predefined processor usage ‘Th_{cpu}’ is defined for the maximum allowed processor usage. Similarly, a predefined network capacity ratio ‘Th_{bw}’ is decided for the maximum allowed bandwidth usage. The network capacity ratio is defined as the ratio of information size to an available bandwidth of the network. The values of Th_{cpu} and Th_{bw} may be expressed as real numbers less than 1, in an embodiment of the invention. These may correspond to percentages of total processor availability and total available bandwidth, respectively.

At 602, the processor usage and the bandwidth usage may be monitored by monitoring module 204. Thereafter, at 604, if the current processor usage is higher than Th_{cpu} and current bandwidth usage is less than Th_{bw}, then at 606, the compression ratio may be decreased. In case the conditions at 604 are not met, the process proceeds to 608. At 608, if the actual bandwidth is higher than Th_{bw} and the actual processor usage is lower than Th_{cpu}, then at 610 the compression ratio may be decreased. Therefore, a tradeoff is done between the processor usage and available bandwidth to adjust compression of the information.

In case the conditions at 608 are not met, the process proceeds to 612. At 612, if the actual bandwidth usage is less than Th_{bw} and actual processor usage is lower than Th_{cpu}, then at 614, the compression ratio may be left unchanged. In an embodiment of the invention, a linear optimization algorithm may be used to optimize both processor usage and bandwidth usage. As a result, efficiency of communication in the network may be improved.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing apparatus or computing devices to produce machines, such that the instructions which execute on the computers or other programmable data processing apparatus create means for implementing the functions specified in the block or blocks. Such computer program instructions may also be stored in a computer-readable medium, such as a memory, that can direct a computing device or other programmable data processing apparatus to function in a particular manner, such that the instructions stored in the computer-readable medium produce an article of manufacture including instruction means that implement the function specified in the block or blocks. Furthermore, such computer program instructions may be provided for download via a network and/or may be downloaded via a network.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A communication method comprising:
establishing a connection between the first device and a second device of the network;
monitoring the first device for one or more performance parameters;
processing full state information of an application at the first device, wherein the full state information is processed based on the performance parameters;
transmitting the processed full state information of the application by the first device to the second device;
processing one or more state changes of the application at the first device, wherein the state changes are processed based on the one or more performance parameters, and wherein the state changes are processed while the connection is active; and
transmitting sequentially one or more processed state changes of the application by the first device to the second device.

2. The method of claim 1, wherein the performance parameters comprise processor usage of the first device.

3. The method of claim 1, wherein the performance parameters comprise available bandwidth of the network at the first device.

4. The method of claim 1, wherein the performance parameters comprise bandwidth usage of the network at the first device.

5. The method of claim 1, wherein the performance parameters comprise latency in communication between the first device and the second device.

6. The method of claim 1, wherein the performance parameters comprise usage statistics of a user at the first device.

7. The method of claim 1, wherein the performance parameters comprise a network capacity ratio.

8. The method of claim 7, wherein the network capacity ratio comprises a ratio of information size to an available bandwidth of the network.

9. The method of claim 1, wherein the application comprises an online game.

10. The method of claim 1, wherein the application comprises an online chat application.

11. The method of claim 1, wherein the processing the full state information of the application comprises compressing the full state information.

12. The method of claim 11, wherein the processing the full state information of the application further comprises:
increasing a compression ratio when a processor usage is lower than a predefined processor usage and a network capacity is greater than a predefined network capacity ratio; and
decreasing the compression ratio when the processor usage is greater than the predefined processor usage and the network capacity is lower than the predefined network capacity ratio.

13. The method of claim 1, wherein the processing the state changes of the application comprises compressing the state changes.

14. The method of claim 13, wherein the processing the state changes of the application comprises:
increasing a compression ratio when a processor usage is lower than a predefined processor usage and a network capacity is greater than a predefined network capacity ratio; and
decreasing the compression ratio when the processor usage is greater than the predefined processor usage and the network capacity is lower than the predefined network capacity ratio.

15. The method of claim 1 further comprising:
receiving the processed full state information of the application at the second device from the first device;
processing the processed full state information of the application at the second device.
receiving sequentially the one or more processed state changes of the application at the second device from the first device; and
processing the processed one or more state changes of the application at the second device, wherein the processed state changes are processed while the connection is active.

16. The method of claim 15, wherein the processing the processed full state information of the application comprises decompressing the processed full state information.

17. The method of claim 15, wherein the processing the processed state changes of the application comprises decompressing the processed state changes.

18. The method of claim 1 further comprising storing the full state information of the application, the state changes of the application and the performance parameters.

19. The method of claim 1, further comprising downloading instructions that, if executed by a computing device, cause the computing device to implement at least the monitoring, processing full state information, and processing one or more state changes.

20. The method of claim 1, further comprising providing for download instructions that, if executed by a computing device, cause the computing device to implement at least the monitoring, processing full state information, and processing one or more state changes.

21. An apparatus for communication in a network, the apparatus comprising:
memory configured to store full state information of an application and one or more state changes of the application;
a monitoring module configured to monitor one or more performance parameters;
an analyzer module configured to process the full state information and the state changes of the application based on the one or more performance parameters, and wherein the state changes are processed while a network connection is active; and
a transmission module configured to:
establish the connection in the network;
transmit the processed full state information; and
transmit sequentially the processed state changes.

22. The apparatus of claim 21, wherein the performance parameters comprise a processor usage.

23. The apparatus of claim 21, wherein the performance parameters comprise an available bandwidth of the network.

24. The apparatus of claim 21, wherein the performance parameters comprise a bandwidth usage of the network.

25. The apparatus of claim 21, wherein the performance parameters comprise a usage statistics of a user.

26. The apparatus of claim 21, wherein the performance parameters comprise a network capacity ratio.

27. The system of claim 21, wherein the network capacity ratio comprises a ratio of information size to an available bandwidth of the network.

28. The apparatus of claim 21, wherein the application comprises an online game.

29. The apparatus of claim 21, wherein the application comprises an online chat application.

30. The apparatus of claim 21, wherein the analyzer module is configured to compress the full state information and the one or more state changes of the application.

31. The apparatus of claim 21, wherein the analyzer module is configured to decompress the full state information and the one or more state changes of the application.

32. The apparatus of claim 21, wherein the analyzer module is further configured to:
increase a compression ratio when a processor usage is lower than a predefined processor usage and a network capacity is greater than a predefined network capacity ratio; and
decrease the compression ratio when the processor usage is greater than the predefined processor usage and the network capacity is lower than the predefined network capacity ratio.

33. The apparatus of claim 21, wherein the transmission module is further configured to receive processed full state information of the application and processed state changes of the application.

34. The apparatus of claim 21, wherein the analyzer module is further configured to decompress compressed information received by the apparatus.

35. A system for efficient communication in a network, the system comprising:
means for establishing a connection between a first device and a second device in the network;
means for monitoring the first device for one or more performance parameters;
means for processing a full state information of the application at the first device, wherein the full state information is processed based on the performance parameters;
means for transmitting the processed full state information of the application by the first device to the second device;
means for processing one or more state changes of the application at the first device, wherein the state changes are processed based on the one or more performance parameters, and wherein the state changes are processed while the connection is active; and
means for transmitting sequentially one or more processed state changes of the application by the first device to the second device.

36. The system of claim 35, wherein the means for processing comprises means for compressing the full state information and the state changes of the application.

37. The system of claim 35, wherein the means for processing comprises means for decompressing the full state information and the state changes of the application.

38. The system of claim 35, wherein the means for processing further comprises:
means for increasing a compression ratio when a processor usage is lower than a predefined processor usage and a network capacity is greater than a predefined network capacity ratio; and
means for decreasing the compression ratio when the processor usage is greater than the predefined processor usage and the network capacity is lower than the predefined network capacity ratio.

39. The system of claim 35, wherein the means for transmitting further comprising means for receiving the processed full state information of the application and the processed state changes of the application.

40. A computer-readable medium containing instructions that, if executed by a computing device, cause the computing device to implement a method comprising:
establishing a connection between a first device, including the computing device, and a second device in the network;
monitoring the first device for one or more performance parameters;
processing full state information of an application at the first device, wherein the full state information is processed based on the performance parameters;
transmitting the processed full state information of the application by the first device to the second device;
processing one or more state changes of the application at the first device, wherein the state changes are processed based on the one or more performance parameters, and wherein the state changes are processed while the connection is active; and
transmitting sequentially one or more processed state changes of the application by the first device to the second device.

41. The computer-readable medium of claim 40, wherein the processing comprises compressing the full state information and the state changes of the application.

42. The computer-readable medium of claim 40, wherein the processing comprises decompressing the processed full state information and the processed state changes of the application.

43. The computer-readable medium of claim 40, wherein the processing further comprises:
increasing a compression ratio when a processor usage is lower than a predefined processor usage and a network capacity is greater than a predefined network capacity ratio; and
decreasing the compression ratio when the processor usage is greater than the predefined processor usage and the network capacity is lower than the predefined network capacity ratio.

44. The computer-readable medium of claim 40, wherein the application comprises an online game.

45. The computer-readable medium of claim 40, wherein the application comprises an online chat application.

46. A communication method comprising:
receiving, by a first device of a network, information from a second device of the network;
processing the information to obtain full state information corresponding to an application;
receiving, by the first device, at least one subsequent information transmission from the second device; and
processing the at least one subsequent information transmission to obtain state change information relating to the application.

47. The method of claim 46, wherein each of processing the information and processing the at least one subsequent information transmission comprises performing data decompression, wherein the information and the at least one subsequent information transmission were compressed prior to transmission using compression based on one or more performance parameters determined for the second device.

48. The method of claim 47, wherein a compression ratio of the compression is adaptive based on the one or more performance parameters.
